(19) United States
(12) Patent Application Publication
(10) Pub. No.: US 2026/0323792 A1
(43) Pub. Date: Oct. 15, 2026

(54) DRAWER-TYPE KITCHEN APPLIANCE AND DOUBLE-LAYER COMBINED DRAWER-TYPE KITCHEN APPLIANCE

(71) Applicant: ARDA (ZHEJIANG) ELECTRIC CO., LTD, Zhejiang (CN)

(72) Inventors: Zhonghuai HU, Zhejiang (CN); Sheng QIAN, Zhejiang (CN); Yayun ZHANG, Zhejiang (CN); Jiabao LIU, Zhejiang (CN); Zhiwei QIU, Zhejiang (CN); Jiangjun PAN, Zhejiang (CN)

(73) Assignee: ARDA (ZHEJIANG) ELECTRIC CO., LTD, Zhejiang (CN)

(21) Appl. No.: 19/646,497

(22) Filed: Apr. 13, 2026

(30) Foreign Application Priority Data
Apr. 14, 2025 (CN) 202520701368.4
Jul. 25, 2025 (CN) 202511034735.0
Jul. 25, 2025 (CN) 202521572790.0
Jul. 25, 2025 (CN) 202521579876.6

(51) Int. Cl. H05B 6/64

(52) U.S. Cl. CPC H05B 6/6402

(57) ABSTRACT

The present disclosure belongs to the technical field of kitchen appliances and specifically relates to a drawer-type kitchen appliance and a double-layer combined drawer-type kitchen appliance. The kitchen appliance includes an oven, a left slide rail assembly, a right slide rail assembly, a drawer, and a drawer opening/closing device, where the drawer has a drawer storage frame, a drawer door, and side connectors respectively installed on left and right sides of the drawer door. The side connectors are mounted on the corresponding left slide rail assembly and the right slide rail assembly, respectively. The drawer opening/closing device includes: a synchronous belt assembly, having a driving pulley, a driven pulley, and a synchronous belt arranged therebetween; a motor, configured to drive the driving pulley to rotate; and a linkage part, having one end fixed to the synchronous belt and the other end fixed to the side connector.

### CROSS-REFERENCE TO RELATED APPLICATION

This application claims the priority benefit of China application serial no. 202520701368.4, filed on Apr. 14, 2025, China application serial no. 202511034735.0, filed on Jul. 25, 2025, China application serial no. 202521572790.0, filed on July. 25, 2025 and China application serial no. 202521579876.6, filed on Jul. 25, 2025. The entirety of each of the above-mentioned patent applications is hereby incorporated by reference herein and made a part of this specification.

### TECHNICAL FIELD

The present disclosure belongs to the technical field of kitchen appliances, and specifically relates to a drawer-type kitchen appliance and a double-layer combined drawer-type kitchen appliance.

### BACKGROUND

A microwave oven is a common kitchen appliance for heating food with microwaves.

A conventional microwave oven includes a chassis, a microwave generating device located on a side wall of the chassis, and an oven door rotatably arranged on a front side thereof. A cavity of the chassis is relatively deep and is internally provided with a turntable, and plates are typically placed and removed horizontally, making it inconvenient to handle large-sized plates. Additionally, enough space needs to be formed in front of the microwave oven for opening the oven door. Users need to squat or bend over for operation when the microwave oven is installed under a cabinet or a countertop (especially at a height less than 50cm above the ground), which is not suitable for small kitchens or modern minimalist kitchen decoration styles. To address these issues, drawer-type microwave ovens have become available on the market. Such a microwave oven includes a chassis, and a drawer slidably arranged inside a chassis body. When the drawer is opened, users can directly place and remove plates vertically, so that the microwave oven can be installed under a relatively low cabinet or countertop, facilitating the handling of large-sized plates with less effort. However, most drawer-style models exhibit unstable opening mechanisms, and have issues such as excessive noise, low control precision, and inconvenient installation.

In addition, the microwaves generated by the microwave generating device are repeatedly reflected within a metal inner cavity of the chassis, forming a complex electromagnetic field distribution. Such an electromagnetic field can cause polar molecules such as water molecules in food to vibrate at high speed, and friction between the molecules generates heat, thereby achieving rapid heating from the inside out. However, since the drawer structure occupies part of the side area, the microwaves emitted by the microwave generating device are easily disrupted by the drawer, affecting the efficiency of microwave heating.

Furthermore, due to the limitations of the heating principle, microwave ovens cannot provide a crispy, browned surface on food, and are therefore not suitable for cooking that requires a baking effect. By adopting thermal radiation and convection heating methods, ovens can achieve desired baking effects, but suffers from relatively low heating efficiency. Especially for large pieces of food materials, over-browning on the surface often occurs while the interior remains undercooked.

Therefore, there is an urgent need to design a composite heating kitchen appliance with high heating efficiency, fast heating speed, and the ability to bake larger foods.

### SUMMARY

The objective of the present disclosure is to provide a drawer-type kitchen appliance that is simple in structure, easy to use, and capable of offering diverse cooking methods, as well as a double-layer combined drawer-type kitchen appliance.

The objective of the present disclosure is achieved as follows:

A drawer-type kitchen appliance includes: a chassis, having an inner liner and an outer shell; a left slide rail assembly, arranged between left side walls of the inner liner and the outer shell; a right slide rail assembly, arranged between right side walls of the inner liner and the outer shell; a door device, having a drawer storage frame located within the inner liner, a door body for sealing the inner liner, and side connectors respectively installed on left and right sides of the door body, the side connectors being mounted on the corresponding left slide rail assembly and the right slide rail assembly, respectively; and a drawer opening/closing device, arranged on one side of the chassis and configured to drive the door device to open and close, where the drawer opening/closing device includes: a synchronous belt assembly, having a driving pulley, a driven pulley, and a synchronous belt arranged therebetween; a motor, configured to drive the driving pulley to rotate; and a linkage part, having one end fixed to the synchronous belt and the other end fixed to the side connector, where the synchronous belt drives the side connector to perform linear reciprocating motion via the linkage part.

Preferably, the linkage part includes a linkage plate and a fixing clamp block, the linkage plate has a first fixing portion connected to the synchronous belt and a second fixing portion connected to the side connector, and the first fixing portion is fixed to the synchronous belt via the fixing clamp block.

Preferably, the first fixing portion is provided with a tooth slot adapted to a toothed surface of the synchronous belt and at least one first connecting hole for connecting to the fixing clamp block, the fixing clamp block is L-shaped and is provided with a second connecting hole corresponding to the first connecting hole and an insertion slot for inserting the first fixing portion, and a fastener is arranged between the first connecting hole and the second connecting hole; and the first fixing portion is installed on a toothed surface side of the synchronous belt, the fixing clamp block is installed on a non-toothed surface side of the synchronous belt, an end portion of the first fixing portion is inserted into the insertion slot of the fixing clamp block, and an inner end of the first fixing portion is fixed to the fixing clamp block via the fastener.

Preferably, the second fixing portion is bent to form a positioning protrusion and at least one first mounting hole; a tail portion of the side connector is provided with a positioning slot matching the positioning protrusion and a second mounting hole corresponding to the first mounting hole; and the first mounting hole and the second mounting hole are fixedly connected via screws.

Preferably, the synchronous belt assembly further has a pulley mounting seat, and front and rear ends of the pulley mounting seat are respectively provided with driving pulley mounting notches and driven pulley mounting notches; the driving pulley is detachably arranged on the driving pulley mounting notches via a driving pulley auxiliary mounting bracket; and the driven pulley has a driven pulley body and a driven shaft, and end portions of the driven shaft are detachably arranged within the driven pulley mounting notches via fixing nuts.

Preferably, the motor is located above or below the synchronous belt assembly, an output wheel is installed on a main shaft of the motor, an input wheel rotating synchronously is arranged on one side of the driving pulley, and the output wheel and the input wheel are connected via an output belt.

Preferably, a limiting member is arranged at a tail portion of the side connector, and a first micro switch is arranged at a front end of the chassis; when the door device reaches an open position, the limiting member triggers the first micro switch and controls the motor to stop; and/or, the door body is provided with at least one pair of door lock assemblies, corresponding lock holes are formed in the chassis, and a second micro switch is arranged inside each of the lock holes; and when the door device reaches a closed position, the door lock assemblies contact the second micro switches and control the motor to stop.

Preferably, a front vertical beam and a rear vertical beam are separately arranged on one side of the outer shell, and a slide rail fixing crossbeam for installing the left slide rail assembly or the right slide rail assembly is arranged between the front vertical beam and the rear vertical beam; and the left slide rail assembly or the right slide rail assembly includes a slide rail fixed to the slide rail fixing crossbeam and a slider movably arranged on the slide rail, and the slide rail is fixedly connected to the side connector.

Preferably, the drawer-type kitchen appliance further includes at least one bottom slide rail assembly arranged between bottom plates of the inner liner and the outer shell; and the door device further has a bottom connector connected to the bottom slide rail assembly.

Preferably, bottom rollers for rolling on a bottom plate of the inner liner and/or side wall rollers for rolling on side plates of the inner liner are respectively arranged on left and right sides of an inner side of the drawer storage frame away from the door body.

Preferably, a top of the inner liner is provided with an inner liner microwave inlet and a stirring cavity in communication with the inner liner microwave inlet; a microwave generating device is installed on a top of the chassis and includes: a microwave generating mechanism, configured to generate microwaves; a waveguide box, having a waveguide inlet portion connected to the microwave generating mechanism and a waveguide outlet portion connected to the inner liner microwave inlet, for guiding the microwaves into the stirring cavity; and a stirring mechanism, installed on the waveguide box, and provided with a stirring motor, a stirring shaft, and a stirring blade located inside the stirring cavity, the stirring motor driving the stirring blade to rotate via the stirring shaft.

Preferably, the waveguide box is provided with a shaft mounting hole portion, and the stirring shaft is movably arranged inside the shaft mounting hole portion; the stirring mechanism further includes: a first driving member, shaped like an L, with one end clamped onto an output shaft of the stirring motor; and a second driving member, having one end sleeved onto the stirring shaft, and the other end passing through the stirring shaft to connect to the other end of the first driving member.

Preferably, the stirring shaft is movably connected to the shaft mounting hole portion via a shaft sleeve, an outer end of the shaft sleeve is provided with a limiting flange, and a middle side wall thereof is provided with a limiting groove; a limiting bump adapted to the limiting groove is provided inside the shaft mounting hole portion for limiting an axial position of the shaft sleeve; and the second driving member abuts against the shaft sleeve and limits an axial position of the stirring shaft.

Preferably, the waveguide box includes an upper waveguide box body and a lower waveguide box body, and edges of the two are welded and fixed; and the upper waveguide box body is provided with a tuning rod.

Preferably, the microwave generating device further includes a microwave cooling mechanism, the microwave cooling mechanism has a microwave cooling casing and a microwave cooling fan, the microwave cooling casing is internally provided with a microwave air inlet, a microwave cooling channel, and a microwave air outlet that are communicated in sequence, the microwave air outlet is in communication with an outer shell exhaust hole of the outer shell, and the microwave cooling fan is located inside the microwave cooling channel; and the microwave generating mechanism includes a frequency converter and a magnetron arranged within the microwave cooling channel.

Preferably, the drawer-type kitchen appliance further includes a top heating mechanism arranged on the top of the inner liner, the top heating mechanism is a top heating element, and a middle part of the top heating element is provided with a clearance portion for avoiding microwaves; and the microwave generating device and the stirring cavity are both located on the top of the inner liner, and the clearance portion is located directly below the stirring cavity.

Preferably, the drawer-type kitchen appliance further includes a back heating mechanism arranged on a back of the inner liner, the back heating mechanism includes a back heating element, a circulating fan, and a heating element shield, a back heating chamber is formed between the heating element shield and a back plate of the inner liner, the back heating element and the circulating fan are installed inside the back heating chamber, a plurality of first vent holes are formed at positions of the heating element shield corresponding to the circulating fan, and a plurality of second vent holes are formed at positions of the heating element shield corresponding to the back heating element.

A double-layer combined drawer-type kitchen appliance includes: a rack, a first apparatus installed in an upper portion of the rack, and a second apparatus installed in a lower portion of the rack, where the second apparatus includes: a chassis, having an inner liner and an outer shell arranged around a periphery of the inner liner; a door device, having a drawer storage frame located within the inner liner, a door body for sealing the inner liner, and side connectors respectively installed on left and right sides of the door body, the side connectors being respectively installed inside the chassis via slide rail assemblies; and a drawer opening/closing device, arranged on one side of the chassis, and configured to drive the door device to open and close, where the drawer opening/closing device includes: a synchronous belt assembly, having a driving pulley, a driven pulley, and a synchronous belt arranged therebetween; a motor, configured to drive the driving pulley to rotate; and a linkage part, having one end fixed to the synchronous belt and the other end fixed to the side connector, where the synchronous belt drives the side connector to perform linear reciprocating motion via the linkage part.

Preferably, a top of the inner liner is provided with an inner liner microwave inlet and a stirring cavity in communication with the inner liner microwave inlet; the second apparatus further includes a microwave generating device installed on the top of the chassis, including: a microwave generating mechanism, configured to generate microwaves; a waveguide box, having a waveguide inlet portion connected to the microwave generating mechanism and a waveguide outlet portion connected to the inner liner microwave inlet, and configured to guide the microwaves into the stirring cavity; and a stirring mechanism, installed on the waveguide box, and provided with a stirring motor, a stirring shaft, and a stirring blade located inside the stirring cavity, the stirring motor driving the stirring blade to rotate via the stirring shaft.

Preferably, the first apparatus includes: an inner housing, having a baking cavity; an outer housing, arranged around a periphery of the inner housing; a drop-down door mechanism, arranged on a front side of the outer housing, and configured to seal the baking cavity; a baking device, arranged on the inner housing and configured to heat food in the baking cavity; and an oven heat dissipation unit, including an oven heat dissipation channel and an oven cooling fan arranged inside the oven heat dissipation channel, where the oven heat dissipation channel includes an upper heat dissipation channel arranged above the inner housing, a rear heat dissipation channel arranged at a back of the inner housing, and a lower heat dissipation channel arranged below the inner housing, at least one air inlet in communication with the upper heat dissipation channel is formed at an upper end of a front housing plate of the outer housing, and at least one air outlet in communication with the lower heat dissipation channel is formed at a lower end of the front housing plate of the outer housing.

Compared with the prior art, the present disclosure has the following outstanding and beneficial technical effects:
1. The drawer opening/closing device of the present disclosure employs the synchronous belt for transmission, which offers advantages such as low noise, low vibration, and high transmission precision, thereby improving the moving precision and stability of the drawer while reducing the noise generated by opening and closing the drawer.
2. The connection structure of the linkage part and the synchronous belt of the present disclosure can prevent slipping, making the transmission more reliable and precise without damaging the synchronous belt.
3. According to the present disclosure, the linkage part and the side connector are first positioned via the positioning protrusion before being fixed with screws during installation, which can improve assembly efficiency.
4. The present disclosure can effectively control the motor to stop at the open position and the closed position through the first micro switch and the second micro switches, so that the motor is more accurately controlled.
5. The drawer storage frame of the present disclosure is provided with bottom rollers for rolling on the bottom plate of the inner liner and/or side wall rollers for rolling on the side plates of the inner liner, which makes the drawer move more smoothly, prevents food liquids from spilling, and improves the load-bearing capacity of the drawer.
6. The microwave generating device of the present disclosure is located on the top of the inner liner, and microwaves enter the food heating chamber from top to bottom to heat food in cooperation with the drawer-type door device, achieving a better heating effect. Furthermore, the microwave generating device and the electric heating device can not only work independently but also alternately. The microwave generating device performs rapid internal heating, while the electric heating device provides baking and cooking to crisp the food surface. This working method can meet more cooking needs of users, shorten food cooking time, and improve cooking efficiency.
7. The microwave generating device of the present disclosure includes the microwave generating mechanism, the waveguide box, and the stirring mechanism, which can more uniformly guide microwaves into the food heating chamber of the inner liner and improves microwave heating efficiency. Furthermore, the stirring mechanism drives the stirring shaft to rotate via the first driving member and the second driving member, which can compensate for the coaxial error between the stirring motor and the stirring shaft, thereby reducing manufacturing complexity.
8. The waveguide box of the present disclosure is formed by welding the upper waveguide box body and the lower waveguide box body, which can reduce the risk of microwave leakage at the connection; and furthermore, the tuning rod is arranged on the upper waveguide box body to ensure microwave transmission efficiency.
9. The electric heating device of the present disclosure includes the top heating mechanism and the back heating mechanism, which, in cooperation with the microwave generating device, can heat food in different ways. The back heating mechanism can also realize an air frying function, meeting more cooking needs of users. Moreover, the top heating element is concave, with a clearance portion for avoiding microwaves formed in its middle part, which is conducive to improving the heating efficiency of microwaves.

### BRIEF DESCRIPTION OF FIGURES

FIG. 1 is a schematic structural diagram of a first type of kitchen appliance according to the present disclosure.

FIG. 2 is a schematic structural diagram of the first type of kitchen appliance according to the present disclosure with a door device removed.

FIG. 3 is a schematic structural diagram of the door device according to the present disclosure.

FIG. 4 is a first schematic installation diagram of a drawer opening/closing device according to the present disclosure.

FIG. 5 is a second schematic installation diagram of the drawer opening/closing device according to the present disclosure.

FIG. 6 is a schematic structural diagram of the drawer opening/closing device driving a side connector according to the present disclosure.

FIG. 7 is an exploded view of the drawer opening/closing device, a right slide rail assembly, and the side connector according to the present disclosure.

FIG. 8 is a schematic structural diagram of a linkage part connecting a synchronous belt and the side connector according to the present disclosure.

FIG. 9 is an exploded view of the linkage part, the synchronous belt, and the side connector according to the present disclosure.

FIG. 10 is a schematic structural diagram of a second type of kitchen appliance according to the present disclosure.

FIG. 11 is a schematic structural diagram of the second type of kitchen appliance according to the present disclosure with the door device removed.

FIG. 12 is a cross-sectional view of the second type of kitchen appliance according to the present disclosure.

FIG. 13 is a schematic structural diagram of an inner liner, a microwave generating device, and a cooling system according to the present disclosure.

FIG. 14 is a schematic structural diagram of the microwave generating device according to the present disclosure.

FIG. 15 is an exploded view of the inner liner, the microwave generating device, and the cooling system according to the present disclosure.

FIG. 16 is an exploded view of the microwave generating device according to the present disclosure.

FIG. 17 is a cross-sectional view of the microwave generating device according to the present disclosure.

FIG. 18 is a schematic structural diagram of a stirring mechanism according to the present disclosure.

FIG. 19 is a front schematic structural diagram of a double-layer combined kitchen appliance according to the present disclosure.

FIG. 20 is a rear schematic structural diagram of the double-layer combined kitchen appliance according to the present disclosure.

FIG. 21 is a cross-sectional view of the double-layer combined kitchen appliance according to the present disclosure.

FIG. 22 is a schematic structural diagram of a second apparatus according to the present disclosure with the door device removed.

Description of reference numerals in figures:

1 denotes a chassis; 2 denotes a microwave generating device; 3 denotes an electric heating device; 4 denotes a door device; 5 denotes a drawer opening/closing device; 6 denotes slide rail assemblies; 7 denotes a control panel; 8 denotes a cooling system;

11 denotes an inner liner; 111 denotes an inner liner microwave inlet; 112 denotes a stirring cavity; 113 denotes an inner liner exhaust hole; 12 denotes an outer shell; 121 denotes lock holes; 122 denotes a front vertical beam; 123 denotes a rear vertical beam; 124 denotes a slide rail fixing crossbeam; 125 denotes a front panel; 126 denotes a connecting crossbeam; 127 denotes an outer shell exhaust hole; 13 denotes a door sealing ring; 14 denotes a microwave-transparent partition;

21 denotes a microwave generating mechanism; 211 denotes a frequency converter; 212 denotes a magnetron; 22 denotes a waveguide box; 221 denotes a waveguide inlet portion; 222 denotes a waveguide outlet portion; 223 denotes a shaft mounting hole portion; 2231 denotes a limiting bump; 224 denotes an upper waveguide box body; 225 denotes a lower waveguide box body; 226 denotes a tuning rod; 227 denotes a waveguide box mounting base; 23 denotes a stirring mechanism; 231 denotes a stirring motor; 232 denotes a stirring shaft; 233 denotes a stirring blade; 234 denotes a first driving member; 235 denotes a second driving member; 236 denotes a shaft sleeve; 2361 denotes a limiting groove; 237 denotes a motor bracket; 238 denotes a stirring blade connecting base; 24 denotes a microwave cooling mechanism; 241 denotes a microwave cooling casing; 2411 denotes a cooling base; 2412 denotes a first cooling cover; 2413 denotes a second cooling cover; 242 denotes a microwave cooling fan; 243 denotes a microwave air inlet; 244 denotes a microwave air outlet;

31 denotes a top heating mechanism; 311 denotes a clearance portion; 32 denotes a back heating mechanism; 321 denotes a back heating element; 322 denotes a circulating fan; 323 denotes a heating element shield; 3231 denotes first vent holes; 3232 denotes second vent holes;

41 denotes a drawer storage frame; 42 denotes a door body; 43 denotes side connectors; 431 denotes a positioning slot; 432 denotes second mounting holes; 44 denotes a limiting member; 45 denotes door lock assemblies; 46 denotes a bottom connector; 47 denotes bottom rollers; 48 denotes side wall rollers; 49 denotes roller brackets;

51 denotes a synchronous belt assembly; 511 denotes a driving pulley; 512 denotes a driven pulley; 513 denotes a synchronous belt; 514 denotes a pulley mounting seat; 5141 denotes driving pulley mounting notches; 5142 denotes driven pulley mounting notches; 515 denotes a driving pulley auxiliary mounting bracket; 516 denotes bearings; 517 denotes step nuts; 52 denotes a motor; 521 denotes an output wheel; 522 denotes an input wheel; 523 denotes an output belt; 524 denotes a motor fixing plate; 53 denotes a linkage part; 531 denotes a linkage plate; 5311 denotes a first fixing portion; 5312 denotes a second fixing portion; 5313 denotes a tooth slot; 5314 denotes first connecting holes; 5315 denotes first mounting holes; 5316 denotes a positioning protrusion; 532 denotes a fixing clamp block; 5321 denotes second connecting holes; 5322 denotes an insertion slot; 54 denotes a first micro switch;

61 denotes a left slide rail assembly; 611 denotes a slide rail; 612 denotes a slider; 62 denotes a right slide rail assembly; 63 denotes bottom slide rail assemblies;

81 denotes a mounting plate; 82 denotes a cooling cover plate; 83 denotes a chassis cooling fan;

100 denotes a rack; 200 denotes a first apparatus; 300 denotes a second apparatus; 400 denotes a main control panel;

2001 denotes an inner housing; 2002 denotes an outer housing; 2003 denotes a drop-down door mechanism; 2004 denotes a baking device; 2005 denotes an oven heat dissipation unit; 2006 denotes a cooling partition; 2007 denotes a mounting partition; 2008 denotes a thermal insulation partition;

2031 denotes a door cooling air duct; 2032 denotes a door air inlet; 2033 denotes a door air outlet;

2041 denotes a rear air frying device; 2042 denotes an upper heating device; 2043 denotes a lower heating device;

2051 denotes an oven cooling fan; 2052 denotes an upper heat dissipation channel; 2053 denotes a rear heat dissipation channel; 2054 denotes a lower heat dissipation channel; 2055 denotes air inlets; and 2056 denotes air outlets.

### DETAILED DESCRIPTION

The present disclosure will be further described below with reference to specific embodiments.

### Embodiment 1

Provided is a drawer-type kitchen appliance, suitable for appliances such as microwave ovens, ovens, and steamers.

This embodiment takes a microwave oven as an example, which includes a chassis 1, a microwave generating device 2, a left slide rail assembly 61, a right slide rail assembly 62, a door device 4, and a drawer opening/closing device 5.

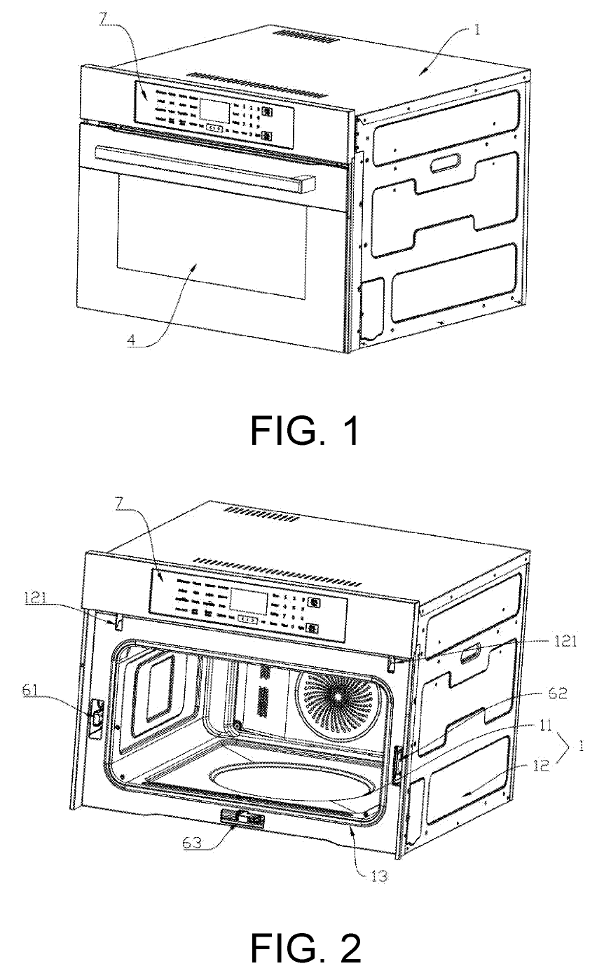

As shown in FIG. 1 and FIG. 2, the chassis 1 includes an inner liner 11, an outer shell 12, and a control panel 7.

The inner liner 11 and the outer shell 12 are each composed of a left side plate, a right-side plate, a top plate, a bottom plate, and a back plate. The inner liner 11 is installed inside the outer shell 12. A front panel 125 is further arranged on the front side of the outer shell 12, and the middle part of the front panel 125 is hollowed out to fit an opening of the inner liner 11. A door sealing ring 13 is installed in a gap between the inner liner 11 and the front panel. The microwave generating device 2 for generating microwaves is arranged between the top plate of the inner liner 11 and the top plate of the outer shell 12. The control panel 7 is provided on the upper side of the front panel 125, and a display screen and corresponding keys are arranged on the control panel 7 for controlling operation of the microwave oven.

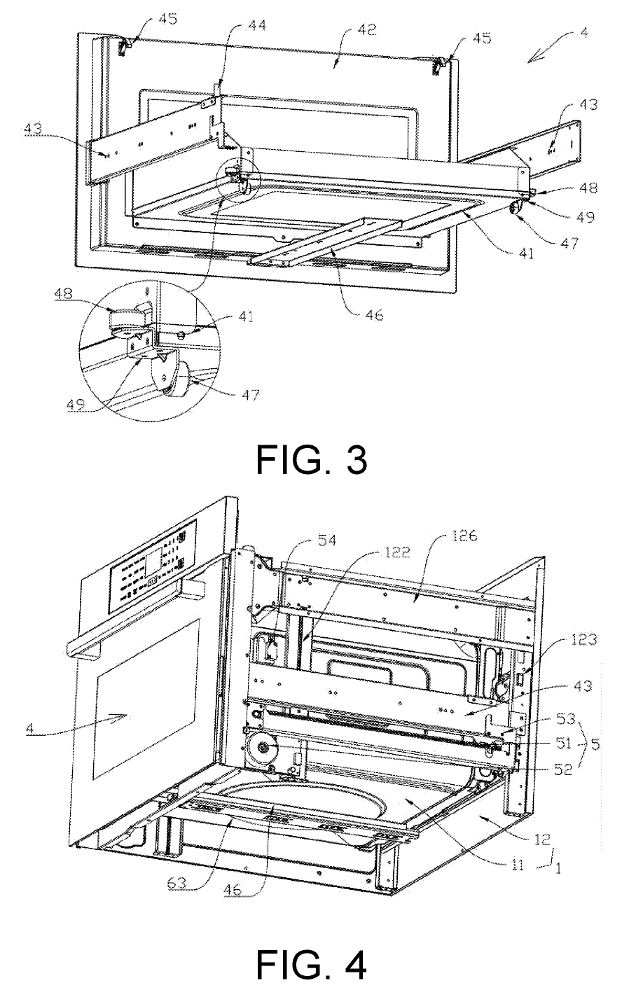

As shown in FIG. 3, the door device 4 has a drawer storage frame 41 located within the inner liner 11, a door body 42 for sealing the inner liner 11, and side connectors 43 respectively installed on the left and right sides of the door body 42. Both the drawer storage frame 41 and the side connectors 43 are installed on the inner side of the door body 42. The drawer storage frame 41 is configured to accommodate food, and the side connectors 43 are configured to connect to the chassis 1.

The door device 4 is mounted to the chassis 1 via the left slide rail assembly 61 and the right slide rail assembly 62, respectively. The left slide rail assembly 61 is arranged between the left side walls (i.e., left side plates) of the inner liner 11 and the outer shell 12, and the right slide rail assembly 62 is arranged between the right-side walls (i.e., right side plates) of the inner liner 11 and the outer shell 12. Side through holes are formed in the front panel 125 for the side connectors 43 to pass through. The two side connectors 43 are mounted on the corresponding left slide rail assembly 61 and the right slide rail assembly 62, respectively, so that the door device 4 is slidably arranged on the chassis 1. When the door device 4 is closed, it abuts against the door sealing ring 13, thereby further improving the sealing performance of the inner liner 11.

Specifically, a front vertical beam 122 and a rear vertical beam 123 are separately arranged on one side of the outer shell 12. The front vertical beam 122 and the rear vertical beam 123 may be separate components, or they may be integrally formed as part of the front panel 125 or the back plate of the outer shell 12. In this embodiment, a connecting crossbeam 126 is fixed between the front panel 125 and the back plate of the outer shell 12, and the connecting crossbeam 126 is located at the top. The front vertical beam 122 and the rear vertical beam 123 are separate components, the rear vertical beam 123 is fixed to the back plate side of the outer shell 12, and the front vertical beam 122 is fixed between the connecting crossbeam 126 and the bottom plate of the outer shell 12. A slide rail fixing crossbeam 124 for installing the left slide rail assembly 61 or the right slide rail assembly 62 is arranged between the front vertical beam 122 and the rear vertical beam 123. In this embodiment, the left slide rail assembly 61 and the right slide rail assembly 62 are basically the same in installation structure and are symmetrically arranged on the left and right sides of the chassis 1.

The left slide rail assembly 61 or the right slide rail assembly 62 includes a slide rail 611 fixed to the slide rail fixing crossbeam 124 and a slider 612 movably arranged on the slide rail, and the slide rail 611 is fixedly connected to the side connector 43.

To make the movement of the door device 4 more stable and reliable, at least one bottom slide rail assembly 63 is further arranged between the bottom plates of the inner liner 11 and the outer shell 12. The bottom slide rail assembly 63 includes a slide rail fixed to the bottom plate of the outer shell 12 and a slider movably arranged on the slide rail. The door device 4 further has a bottom connector 46 connected to the bottom slide rail assembly 63. A bottom through hole is formed in the front panel 125 for the bottom connector 46 to pass through. One end of the bottom connector 46 is fixed to the door body 42 below the drawer storage frame 41, and the other end thereof passes through the bottom through hole and is fixed to the slider of the bottom slide rail assembly 63.

Preferably, roller brackets 49 are respectively arranged on the left and right sides of the inner side of the drawer storage frame 41 away from the door body 42. Bottom rollers 47 for rolling on the bottom plate of the inner liner 11 and/or side wall rollers 48 for rolling on the side plates of the inner liner 11 are installed on the roller brackets 49, which makes the door device 4 move more smoothly, prevents food liquids from spilling, and improves the load-bearing capacity of the drawer.

As shown in FIG. 4, the drawer opening/closing device 5 is arranged on one side of the chassis 1 and is configured to drive the door device 4 to open and close via the side connector 43 on that side. The drawer opening/closing device 5 includes a synchronous belt assembly 51, a motor 52, and a linkage part 53.

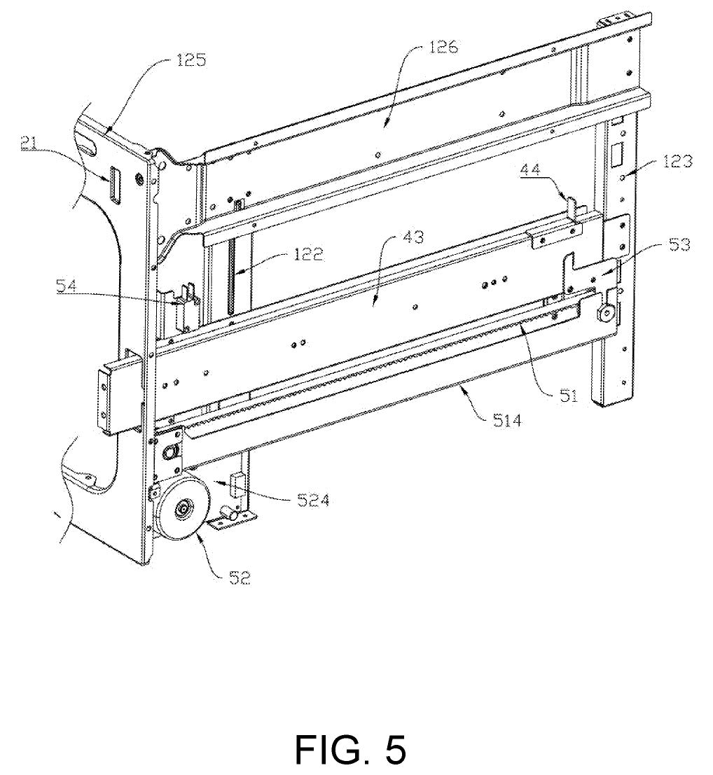

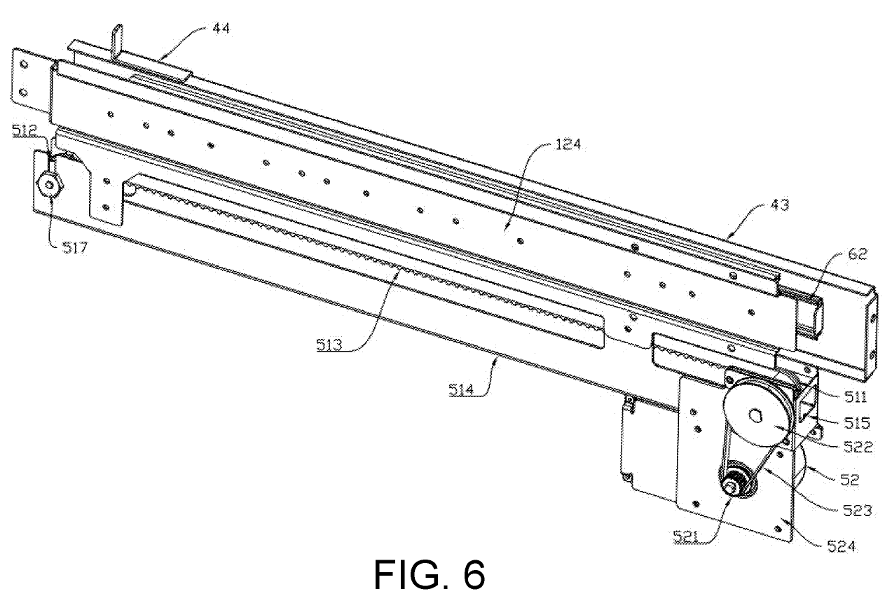

As shown in FIGS. 5 and FIG. 6, the synchronous belt assembly 51 has a pulley mounting seat 514, a driving pulley 511, a driven pulley 512, and a synchronous belt 513 arranged therebetween. The driving pulley 511 and the driven pulley 512 are respectively installed at the two ends of the pulley mounting seat 514, and the pulley mounting seat 514 is directly fixed to the chassis 1. In this embodiment, the pulley mounting seat 514 is fixed to the slide rail fixing crossbeam 124.

In other embodiments, the pulley mounting seat 514 may also be fixed between the front vertical beam 122 and the rear vertical beam 123 or between the front panel 125 and the back plate of the outer shell 12.

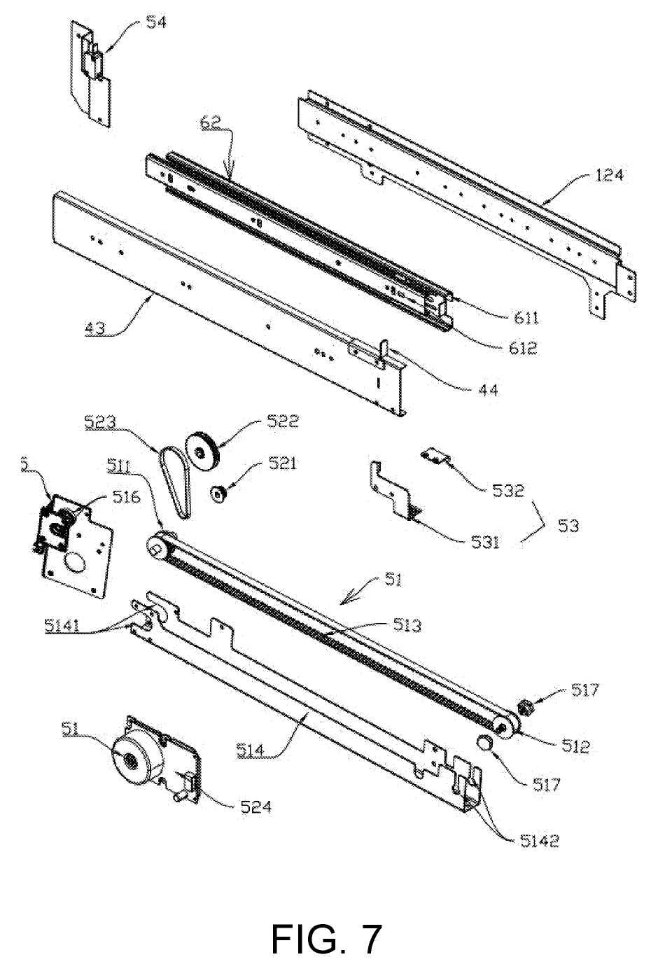

As shown in FIG. 7, the pulley mounting seat 514 is a U-shaped profile, having a bottom wall and left and right channel walls integrally formed on the left and right sides of the bottom wall. To facilitate the installation of the driving pulley 511 and the driven pulley 512, each of the front ends of the left and right channel walls of the pulley mounting seat 514 is provided with a driving pulley mounting notch 5141, and each of the rear ends thereof is provided with a driven pulley mounting notch 5142.

A driving pulley auxiliary mounting bracket 515 and bearings 516 arranged on the driving pulley auxiliary mounting bracket 515 are detachably arranged on the driving pulley mounting notch 5141. The driving pulley 511 has a driving pulley body and a separate driving shaft. The two ends of the driving shaft are installed on the corresponding bearings 516. The driving pulley 511 is first installed on the driving pulley auxiliary mounting bracket 515, and then the driving pulley auxiliary mounting bracket 515 is aligned with the driving pulley mounting notches 5141 and installed onto the pulley mounting seat 514, and finally the two are fixedly connected by screws, achieving a detachable connection between the driving pulley auxiliary mounting bracket 515 and the pulley mounting seat 514.

The driven pulley 512 has a driven pulley body and a driven shaft. The driven pulley mounting notch 5142 has a guide groove portion adapted to the diameter of the driven shaft and a shaft mounting groove portion with a diameter larger than that of the driven shaft, and the guide groove portion and the shaft mounting groove portion are communicated with each other. After the driven shaft enters the shaft mounting groove portion through the guide groove portion, fixing nuts are threadedly connected to the two ends of the driven shaft. In this embodiment, the fixing nuts are step nuts 517, and each step nut 517 has a step portion that can be inserted into the shaft mounting groove portion, thereby preventing the driven shaft from detaching from the driven pulley mounting notch 5142 and achieving quick installation.

In another embodiment, one end of one driven shaft may be integrally formed with a step portion, and the other end thereof is fixedly connected via a step nut 517.

In another embodiment, the driven pulley mounting notch 5142 is a circular driven shaft mounting hole, bearings are arranged inside the driven shaft mounting hole, the driven shaft of the driven pulley 512 is arranged between the two bearings, and the outer end of the driven pulley 512 is limited by a fixing nut or a snap ring.

The motor 52 is configured to drive the driving pulley 511 to rotate. To reduce the installation width, the motor 52 is located above or below the synchronous belt assembly 51. In this embodiment, the motor is located below the synchronous belt assembly 51 and is fixed to one side of the pulley mounting seat 514 via a motor fixing plate 524, forming a stable support structure together with the synchronous belt assembly 51. An output wheel 521 is installed on a main shaft of the motor 52, an input wheel 522 rotating synchronously is arranged on one side of the driving pulley 511, and the output wheel 521 and the input wheel 522 are connected via an output belt 523. The output belt 523 is preferably a synchronous belt. This embodiment employs the synchronous belt for transmission, which offers advantages such as low noise, low vibration, and high transmission precision, thereby improving the moving precision and stability of the door device 4 while reducing the noise generated during operation of the drawer opening/closing device 5.

A linkage part 53 is arranged between the synchronous belt assembly 51 and the side connector 43. One end of the linkage part 53 is fixed to the synchronous belt 513, and the other end thereof is fixed to the side connector 43. The forward and backward reciprocating motion of the synchronous belt 513 enables the side connector 43 and the door device 4 to move linearly back and forth.

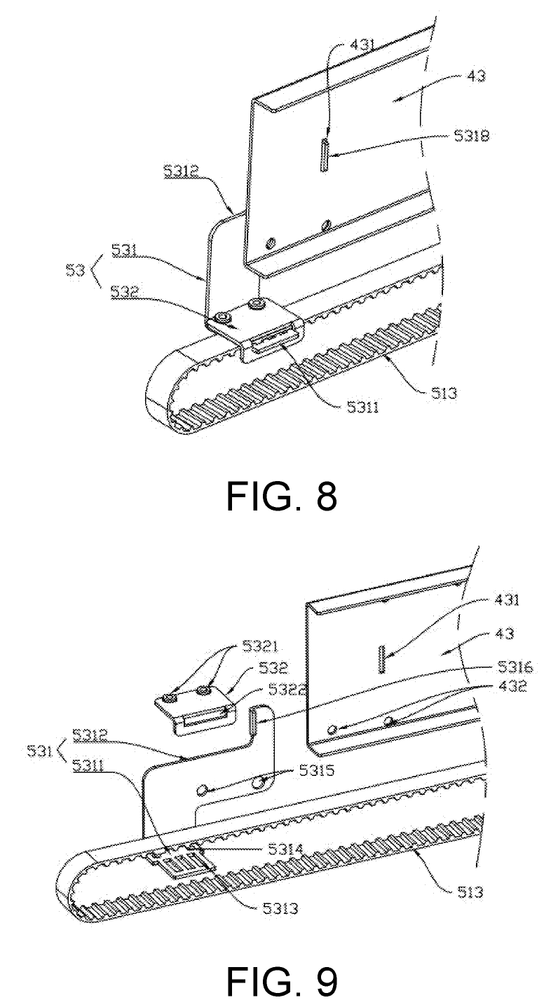

Specifically, as shown in FIGS. 8 and FIG. 9, the linkage part 53 includes a linkage plate 531 and a fixing clamp block 532. The linkage plate 531 is of a sheet structure, having a first fixing portion 5311 connected to the synchronous belt 513 and a second fixing portion 5312 connected to the side connector 43. The first fixing portion 5311 is bent and arranged at the bottom of the second fixing portion 5312, and the two fixing portions are perpendicular to each other.

The first fixing portion 5311 is provided with a tooth slot 5313 adapted to the toothed surface of the synchronous belt 513 and at least one first connecting hole 5314 for connecting to the fixing clamp block 532. The fixing clamp block 532 is L-shaped and is provided with a second connecting hole 5321 corresponding to the first connecting hole 5314 and an insertion slot 5322 for inserting the first fixing portion 5311. A fastener (such as a screw) is arranged between the first connecting hole 5314 and the second connecting hole 5321. The first fixing portion 5311 is installed on the toothed surface side of the synchronous belt 513, and part of the teeth of the toothed surface of the synchronous belt 513 are embedded in the tooth slot 5313. The fixing clamp block 532 is installed on the non-toothed surface side of the synchronous belt 513, the end portion of the first fixing portion 5311 is inserted into the insertion slot 5322 of the fixing clamp block 532, and the inner end of the first fixing portion 5311 is fixed to the fixing clamp block 532 via the fastener (such as the screw), thereby achieving a reliable connection between the linkage part 53 and the synchronous belt 513. In this embodiment, the connection structure of the linkage part 53 and the synchronous belt 513 can prevent slipping, making the transmission more reliable and precise without damaging the synchronous belt.

Additionally, the length of the synchronous belt 513 matches the stroke of the door device 4, and the mounting point of the first fixing portion 5311 on the synchronous belt 513 is always located between the driving pulley 511 and the driven pulley 512, so that no interference with the driving pulley 511 or the driven pulley 512 occurs during movement.

The second fixing portion 5312 is bent to form a positioning protrusion 5316 and at least one first mounting hole 5315, and the positioning protrusion 5316 is preferably arranged vertically. The tail portion of the side connector 43 is provided with a positioning slot 431 matching the positioning protrusion 5316 and a second mounting hole 432 corresponding to the first mounting hole 5315. During installation, the positioning protrusion 5316 is first inserted into the positioning slot 431, and then fixedly connected via screws through the first mounting hole 5315 and the second mounting hole 432, thereby achieving a reliable connection between the linkage part 53 and the side connector 43.

Preferably, a limiting member 44 is arranged at the tail portion of the side connector 43, and the limiting member 44 may be integrally or separately arranged on the side connector 43. To reduce costs, in this embodiment, the side connector 43, the slide rail fixing crossbeam 124, the front vertical beam 122, and the rear vertical beam 123 are all C-shaped section profiles, and the limiting member 44 is separately arranged on the side connector 43 via screws. A first micro switch 54 is arranged at the front end of the chassis 1, and when the door device 4 reaches the open position, the limiting member 44 triggers the first micro switch 54 and controls the motor 52 to stop. Moreover, the interaction between the first micro switch 54 and the limiting member 44 can also prevent the door device 4 from further opening.

In addition, the door body 42 is provided with at least one pair of door lock assemblies 45, and corresponding lock holes 121 are formed in the front panel 125 of the chassis 1. A second micro switch (not shown) is arranged inside each of the lock holes 121. When the door device 4 reaches the closed position, the door lock assemblies 45 contact the second micro switches and control the motor 52 to stop.

In this embodiment, there are two ways to control the door device 4: one is to drive it through a drawer open button and a drawer close button on the control panel 7; and the other is that the user directly pushes or pulls manually, and after the system senses the movement direction of the door device 4, it will activate the motor 52 to open or close the door device 4 accordingly until the first micro switch 54 or the second micro switches are triggered, at which point the motor 52 stops working.

### Embodiment 2

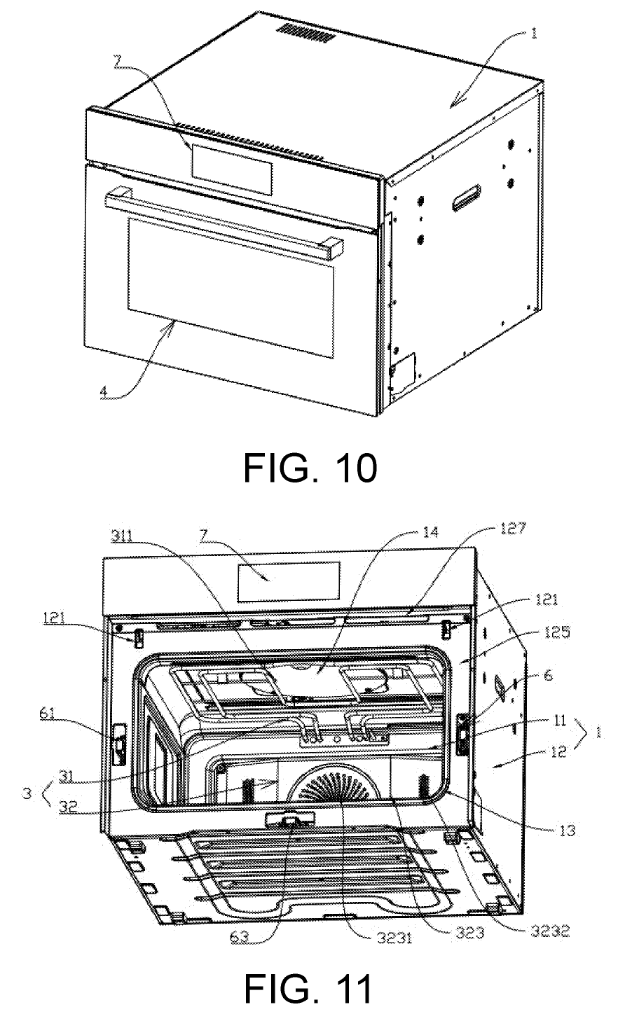

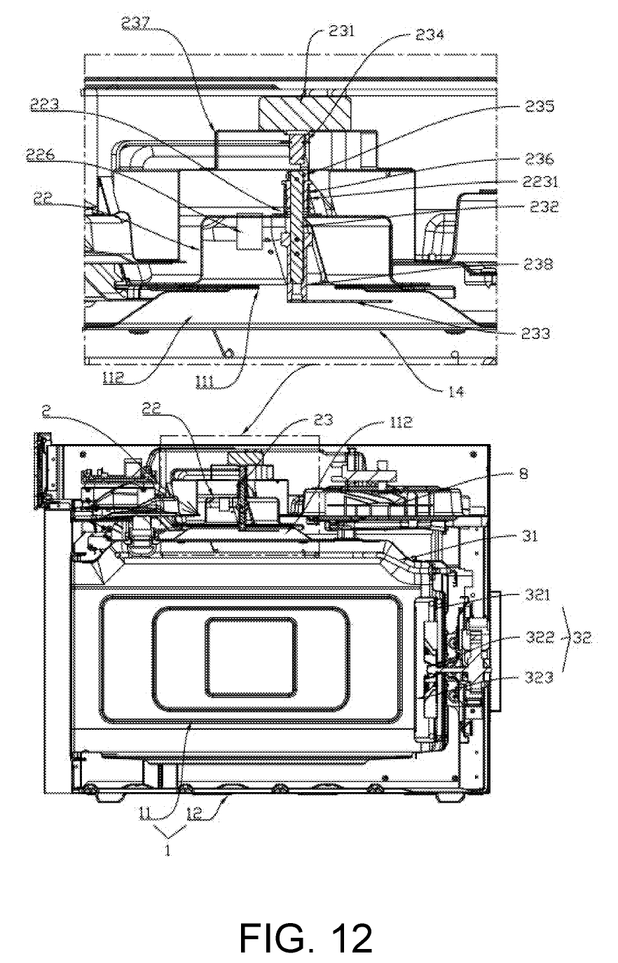

As shown in FIGS. 10 and FIG. 11, this embodiment is a drawer-type microwave-oven combination appliance, which includes a chassis 1, a microwave generating device 2, an electric heating device 3, a door device 4, a drawer opening/closing device 5, and a control panel 7.

As shown in FIGS. 10 and FIG. 11, the chassis 1 includes an inner liner 11 and an outer shell 12 arranged around the periphery of the inner liner 11, a component installation space is formed between the inner liner 11 and the outer shell 12, and a food heating chamber is formed inside the inner liner 11.

The inner liner 11 and the outer shell 12 are each composed of a left side plate, a right-side plate, a top plate, a bottom plate, and a back plate. The plates of the inner liner 11 are fixed together by welding or integral forming. The plates of the outer shell 12 are fixed together by snap-fitting, screw fastening, welding, or integral forming. In this embodiment, the left side plate, bottom plate, and right-side plate of the inner liner 11 are integrally formed and respectively welded to the top plate and the back plate. The plates of the outer shell 12 are fixed together by screws.

The inner liner 11 is installed inside the outer shell 12. A front panel 125 is further arranged on the front side of the outer shell 12, and the middle part of the front panel 125 is hollowed out to fit an opening of the inner liner 11. A door sealing ring 13 is installed in a gap between the inner liner 11 and the front panel 125. A door device 4 cooperating with the door sealing ring 13 is movably provided on the front side of the front panel 125 for sealing the opening of the inner liner 11. The control panel 7 is arranged on the upper side of the front panel 125, and the control panel 7 is provided with a display screen and corresponding keys for controlling operation of electrical components such as the microwave generating device 2, the electric heating device 3, and the drawer opening/closing device 5.

An electric heating device 3 for baking is arranged inside the inner liner 11. The electric heating device 3 includes a top heating mechanism 31 and a back heating mechanism 32.

As shown in FIG. 11, the top heating mechanism 31 is a top heating element installed below the top plate of the inner liner 11.

As shown in FIG. 12, the back heating mechanism 32 includes a back heating element 321, a circulating fan 322, and a heating element shield 323, the heating element shield 323 is fixed to the back plate of the inner liner 11, and a back heating chamber is formed therebetween. The annular back heating element 321 and the circulating fan 322 are installed within the back heating chamber. As shown in FIG. 11, a plurality of first vent holes 3231 are formed at positions of the heating element shield 323 corresponding to the circulating fan 322, and a plurality of second vent holes 3232 are formed at positions of the heating element shield 323 corresponding to the back heating element 321. When the back heating element 321 and the circulating fan 322 are started simultaneously, under the action of the circulating fan 322, air from the food heating chamber enters the back heating chamber through the first vent holes 3231, is heated by the back heating element 321, and is then discharged into the food heating chamber through the second vent holes 3232, thereby continuously circulating to heat the food and achieving an air frying function.

The microwave generating device 2 is configured to generate microwaves and is arranged inside the component installation space between the top plates of the inner liner 11 and the outer shell 12.

Specifically, as shown in FIG. 12, the middle part of the top plate of the inner liner 11 protrudes upward and is provided with an inner liner microwave inlet 111, and the inner liner microwave inlet 111 is a circular opening. A microwave-transparent partition 14 is arranged below the top plate of the inner liner 11 to seal the protruding portion, so that a stirring cavity 112 in communication with the inner liner microwave inlet 111 is formed therebetween. The microwave-transparent partition 14 is made of a non-metallic material, preferably a glass plate or mica sheet, which does not affect the entry of microwaves into the food heating chamber while isolating the stirring cavity 112 from the food heating chamber, so as to prevent steam generated during food cooking from entering the microwave generating device 2.

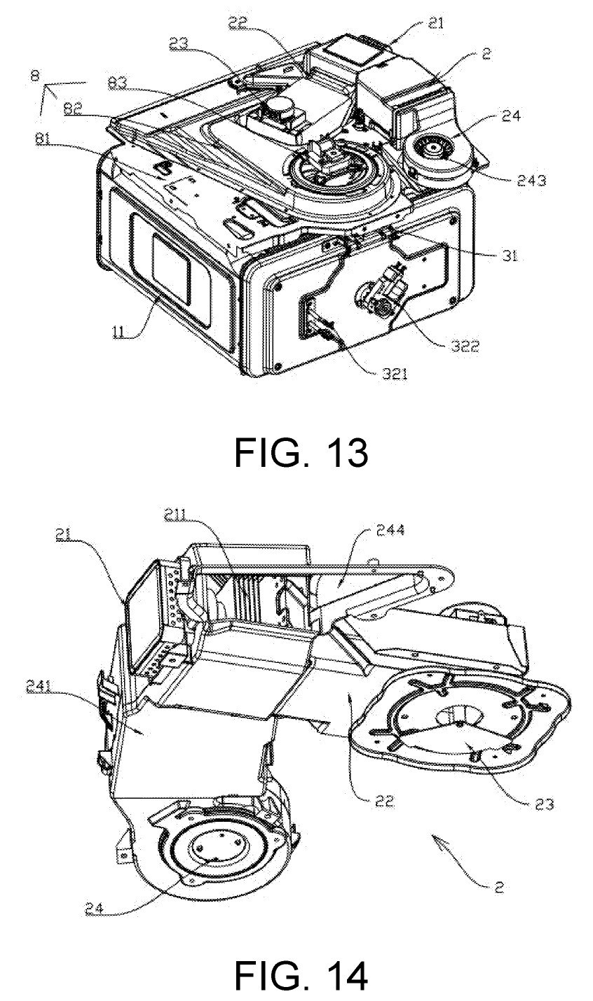

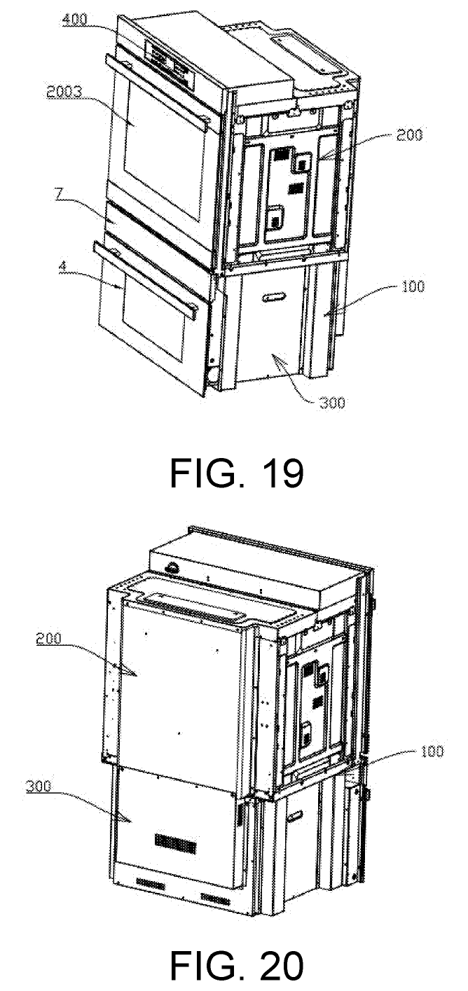

As shown in FIGS. 13 - FIG. 18, the microwave generating device 2 includes a microwave generating mechanism 21, a waveguide box 22, a stirring mechanism 23, and a microwave cooling mechanism 24.

The microwave generating mechanism 21 is configured to generate microwaves and includes a frequency converter 211 and a magnetron 212. The waveguide box 22 is fixed to a microwave emission end of the magnetron 212. The waveguide box 22 has a waveguide inlet portion 221 connected to the microwave emission end and a waveguide outlet portion 222 connected to the inner liner microwave inlet 111, for guiding the microwaves into the stirring cavity 112. The stirring mechanism 23 is installed on the waveguide box 22, and is provided with a stirring motor 231, a stirring shaft 232, and a stirring blade 233 located within the stirring cavity 112. The stirring motor 231 drives the stirring blade 233 to rotate via the stirring shaft 232, allowing the microwaves to enter the food heating chamber of the inner liner 11 more uniformly.

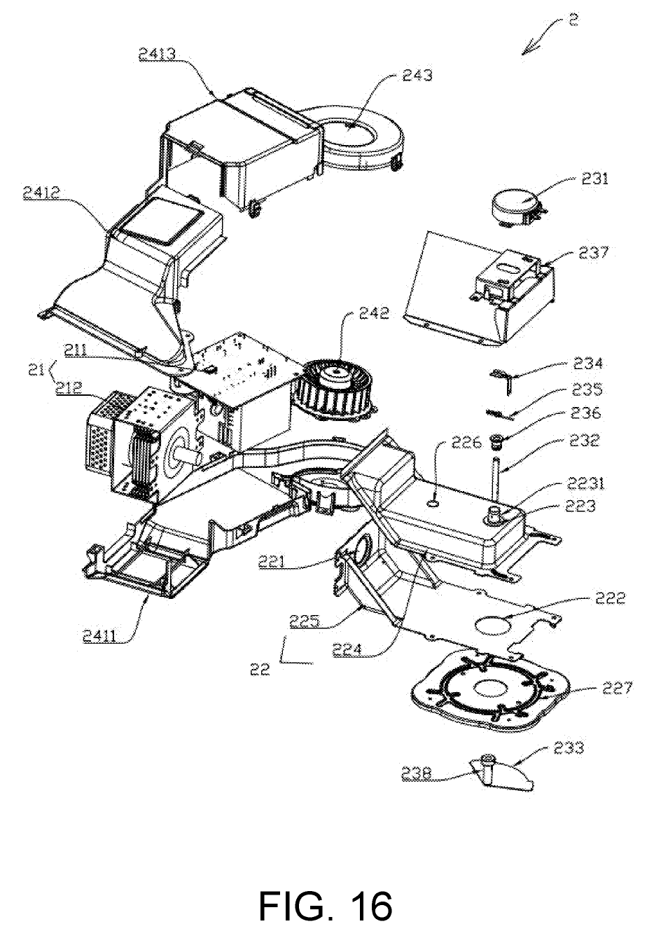

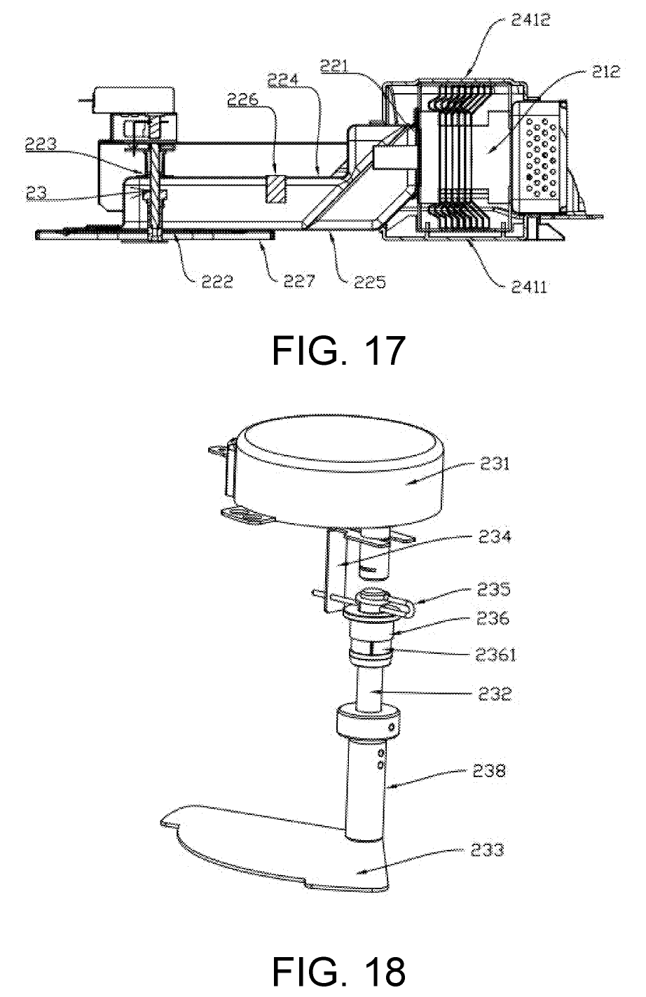

As shown in FIGS. 16 and FIG. 17, in this embodiment, the waveguide box 22 includes an upper waveguide box body 224 and a lower waveguide box body 225. The lower waveguide box body 225 is L-shaped, having a side wall forming the waveguide inlet portion 221 and a bottom wall forming the waveguide outlet portion 222. A sloped transition is formed by draw forming between the side wall and the bottom wall. The waveguide inlet portion 221 and the waveguide outlet portion 222 are both circular openings. A stepped cavity is formed inside the upper waveguide box body 224 and is welded and fixed to the lower waveguide box body 225 along its edges to form an L-shaped waveguide cavity, thereby reducing the risk of microwave leakage. The upper waveguide box body 224 is provided with a tuning rod 226, the length of the tuning rod 226 extending into the waveguide cavity is 9mm to 13mm, and its function is to change the capacitive reactance in the waveguide box 22 to match the impedance with the microwave generating mechanism 21, thereby effectively eliminating reflected waves and ensuring higher microwave transmission efficiency.

In addition, first mounting holes and second mounting holes are also formed on the edge of the waveguide box 22. Screws can be inserted through the first mounting holes for connecting to the microwave emission end, and screws can be inserted through the second mounting holes for connecting to a waveguide box mounting base 227 on the top of the inner liner 11. The waveguide box mounting base 227 is fixed at the inner liner microwave inlet 111 of the inner liner 11.

As shown in FIG. 17, the waveguide box 22 is provided with a shaft mounting hole portion 223, and the shaft mounting hole portion 223 is a shaft seat welded to the upper waveguide box body 224 and is located directly above the waveguide outlet portion 222.

As shown in FIGS. 12, FIG. 16 and FIG. 18, the stirring shaft 232 is movably connected to the shaft mounting hole portion 223 via a shaft sleeve 236, the outer end of the shaft sleeve 236 is provided with a limiting flange, and the middle side wall thereof is provided with a limiting groove 2361. A limiting bump 2231 adapted to the limiting groove 2361 is arranged inside the shaft mounting hole portion 223 for limiting the axial position of the shaft sleeve 236.

A motor bracket 237 is arranged on the outside of the waveguide box 22, the stirring motor 231 is fixed to the motor bracket 237, a clamping slot is provided on an output shaft of the stirring motor 231, a first driving member 234 is clamped into the clamping slot, and the first driving member 234 is L-shaped. A second driving member 235 is arranged at the upper end of the stirring shaft 232, one end of the second driving member 235 is sleeved onto the stirring shaft 232, and the other end passes through the stirring shaft 232 to connect to the other end of the first driving member 234. Preferably, the second driving member 235 is a spring pin.

The stirring motor 231 drives the stirring shaft 232 to rotate via the first driving member 234 and the second driving member 235. This structure can compensate for the coaxial error between the stirring motor 231 and the stirring shaft 232, reducing manufacturing complexity. Additionally, the second driving member 235 abuts against the shaft sleeve 236 and limits the downward axial position of the stirring shaft 232.

The lower end of the stirring shaft 232 enters the waveguide cavity and is fixed with the stirring blade 233 via a stirring blade connecting base 238. The stirring blade 233 is fan-shaped and is located within the stirring cavity 112, which is fixed to the stirring blade connecting base 238 by screws, and the stirring blade connecting base 238 is connected to the lower end of the stirring shaft 232 via a fixing pin. Generally, for the same model of equipment, the axial position of the stirring blade connecting base 238 and the stirring shaft 232 is fixed. However, for different models, manufacturers can adjust the height position of the stirring blade 233 within the stirring cavity 112 by changing the relative position of the stirring blade connecting base 238 and the stirring shaft 232, so as to achieve a better stirring effect.

As shown in FIG. 16, the microwave cooling mechanism 24 has a microwave cooling casing 241 and a microwave cooling fan 242, the microwave cooling casing 241 is internally provided with a microwave air inlet 243, a microwave cooling channel, and a microwave air outlet 244 that are communicated in sequence, the microwave air inlet 243 is in communication with the component installation space, and the microwave air outlet 244 is in communication with an outer shell exhaust hole 127 of the outer shell 12 (i.e., the front panel 125). In this embodiment, there are a plurality of outer shell exhaust holes 127 arranged transversely in a gap between the door device 4 and the control panel 7.

Specifically, the microwave cooling casing 241 includes a cooling base 2411, a first cooling cover 2412, and a second cooling cover 2413. The cooling base 2411 is available for fixation on a mounting plate 81. The first cooling cover 2412 and the second cooling cover 2413 are assembled together and then fixed to the cooling base 2411, thereby forming the microwave cooling channel. The microwave cooling fan 242, the frequency converter 211, and the magnetron 212 are sequentially arranged inside the microwave cooling channel. The first cooling cover 2412 covers the magnetron 212, so that the microwave cooling channel is aligned with the direction of a heat dissipation air duct of the magnetron 212 itself. Furthermore, the first cooling cover 2412 and the cooling base 2411 form the microwave air outlet 244, and the microwave air outlet 244 is in communication with the outside through the outer shell exhaust holes 127. The second cooling cover 2413 covers the microwave cooling fan 242 and the frequency converter 211 and is formed with the microwave air inlet 243 in communication with the component installation space. Under the action of the microwave cooling fan 242, air from the component installation space can sequentially pass through the microwave air inlet 243, the microwave cooling channel, and the microwave air outlet 244 to be discharged to the outside, thereby reducing the operating temperature of the frequency converter 211 and the magnetron 212. It should be noted that the outer shell 12 is provided with heat emission holes that communicate the outside with the component installation space, which ensures that the component installation space can directly draw in air from the outside under negative pressure.

Additionally, as shown in FIG. 11, the top heating element is made of a metal material, which increases microwave loss. Therefore, the top heating element in this embodiment is concave, with a clearance portion 311 for avoiding microwaves formed in its middle part, and the clearance portion 311 is located directly below the stirring cavity 112, which is conducive to improving the heating efficiency of microwaves.

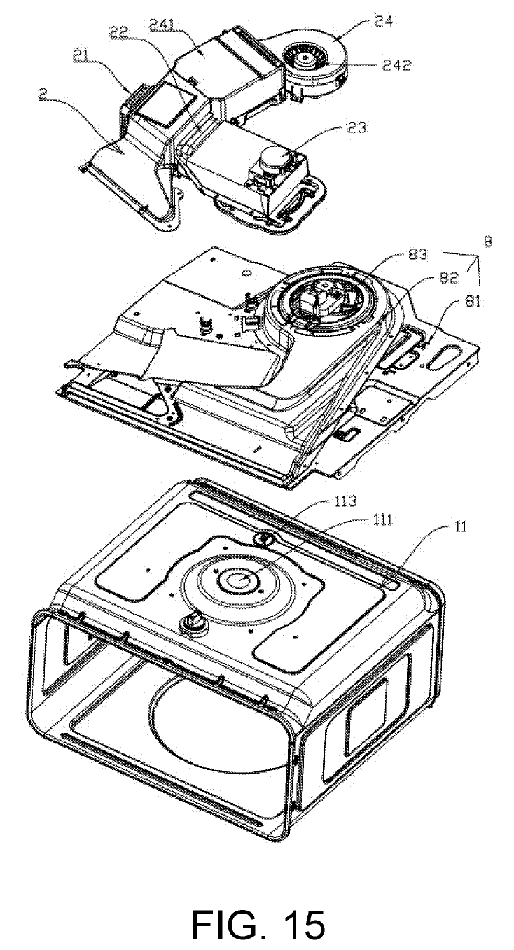

As shown in FIG. 15, a main control board for controlling the microwave generating device 2 and the electric heating device 3, and a cooling system 8 are further arranged in the component installation space, the main control board is electrically connected to the control panel 7, the cooling system 8 includes the mounting plate 81 arranged above the top plate of the inner liner 11, a cooling cover plate 82 arranged on the mounting plate 81, and a chassis cooling fan 83, a main cooling channel is formed between the cooling cover plate 82 and the mounting plate 81, one end of the main cooling channel is provided with a main cooling inlet in communication with the component installation space, the other end thereof is provided with a main cooling outlet, and the main cooling outlet is in communication with the outer shell exhaust holes 127 of the outer shell 12 (front panel 125). The chassis cooling fan 83 is installed at the main cooling inlet of the main cooling channel.

In addition, an inner liner exhaust hole 113 is formed in the top plate of the inner liner 11, and the inner liner exhaust hole 113 is in communication with the main cooling channel via an inner liner exhaust pipe fitting. The cooling system 8 is used for dissipating heat from the electrical components within the component installation space and the inner liner 11.

The structures of the door device 4 and the drawer opening/closing device 5 in this embodiment are substantially the same as those in Embodiment 1. The differences are as follows:

Referring to FIG. 3, the door device 4 has a drawer storage frame 41 located within the inner liner 11, a door body 42 for sealing the inner liner 11, and side connectors 43 respectively installed on the left and right sides of the door body 42, both the drawer storage frame 41 and the side connectors 43 are installed on the inner side of the door body 42, a food tray is arranged at the bottom of the drawer storage frame 41, the food tray is made of a non-metallic material, preferably a glass plate or a mica sheet, and the side connectors 43 are configured to connect to the chassis 1.

As shown in FIG. 11, the door device 4 is mounted to the chassis 1 via slide rail assemblies 6, and the slide rail assemblies 6 include a left slide rail assembly 61 and a right slide rail assembly 62. The left slide rail assembly 61 is arranged between the left side walls (i.e., left side plates) of the inner liner 11 and the outer shell 12, and the right slide rail assembly 62 is arranged between the right-side walls (i.e., right side plates) of the inner liner 11 and the outer shell 12. Side through holes are formed in the front panel 125 for the side connectors 43 to pass through. The two side connectors 43 are mounted on the corresponding left slide rail assembly 61 and the right slide rail assembly 62, respectively, so that the door device 4 is slidably arranged on the chassis 1. When the door device 4 is closed, it abuts against the door sealing ring 13, thereby further improving the sealing performance of the inner liner 11.

Furthermore, the door body 42 is provided with at least one pair of door lock assemblies 45, and corresponding lock holes 121 are formed in the front panel 125 of the chassis 1. A second micro switch (not shown) is arranged inside one of the lock holes 121. When the door device 4 reaches the closed position, the door lock assemblies 45 contact the second micro switch and control the motor 52 to stop. Additionally, two third micro switches (not shown) are arranged inside the other lock hole 121. The door lock assemblies 45 can simultaneously trigger the third micro switches and connect power supply circuits for controlling the microwave generating device 2 and the electric heating device 3 through the main control board.

### Embodiment 3

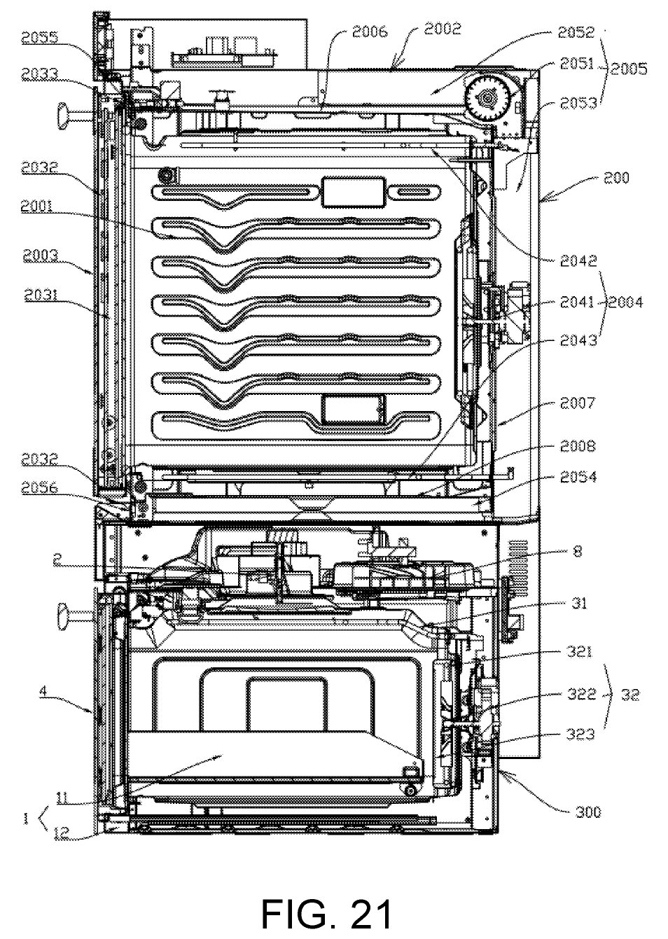

As shown in FIGS. 19 - FIG. 21, a double-layer combined drawer-type kitchen appliance includes a rack 100, a first apparatus 200, and a second apparatus 300. The first apparatus 200 is installed in an upper portion of the rack 100, and the second apparatus 300 is installed in a lower portion of the rack 100.

In this embodiment, the rack 100 includes a left rack and a right rack, each composed of a horizontal beam and two vertical beams, with the horizontal beam fixed to the upper ends of the two vertical beams. The width of the first apparatus 200 is greater than that of the second apparatus 300, and the first apparatus 200 is located above the second apparatus 300. In this case, the first apparatus 200 is fixed to the horizontal beams of the left rack and the right rack, and the second apparatus 300 is installed between the left rack and the right rack, and left and right-side walls of the second apparatus 300 respectively fixed to the left rack and the right rack.

The first apparatus 200 is one of an oven, a steamer, a dishwasher, and a disinfection cabinet.

As shown in FIG. 21, the first apparatus 200 in this embodiment is an oven, including an inner housing 2001, an outer housing 2002, a drop-down door mechanism 2003, a baking device 2004, and an oven heat dissipation unit 2005.

The inner housing 2001 and the outer housing 2002 are each composed of a left housing plate, a right housing plate, a top housing plate, a bottom housing plate, and a back housing plate. The plates of the inner housing 2001 are fixed together by welding or integral forming. The plates of the outer housing 2002 are fixed together by snap-fitting, screw fastening, welding, or integral forming.

The inner housing 2001 has a baking cavity, the outer housing 2002 is arranged around the periphery of the inner housing 2001, and the outer housing 2002 further has a front housing plate located on the front side of the inner housing 2001 and having an opening in communication with the baking cavity. The drop-down door mechanism 2003 is arranged on the front side of the front housing plate via a hinge structure for sealing the baking cavity.

The baking device 2004 is arranged on the inner housing 2001 for heating food in the baking cavity. The baking device 2004 includes a rear air frying device 2041 arranged at the back of the baking cavity (i.e., the back housing plate of the inner housing 2001), an upper heating device 2042 arranged at the upper end of the baking cavity, and a lower heating device 2043 located below the baking cavity. The upper heating device 2042 is an upper heating element fixed to the upper end of the back housing plate of the inner housing 2001 and located below the top housing plate of the inner housing 2001. The lower heating device 2043 includes a lower heating element and a heating element mounting plate. The lower heating element is installed below the bottom housing plate of the inner housing 2001 via the heating element mounting plate.

The oven heat dissipation unit 2005 includes an oven heat dissipation channel and an oven cooling fan 2051 arranged inside the oven heat dissipation channel. The oven heat dissipation channel includes an upper heat dissipation channel 2052 arranged above the inner housing 2001, a rear heat dissipation channel 2053 arranged at the back of the inner housing 2001, and a lower heat dissipation channel 2054 arranged below the inner housing 2001. At least one air inlet 2055 in communication with the upper heat dissipation channel 2052 is formed at the upper end of the front housing plate of the outer housing 2002, and at least one air outlet 2056 in communication with the lower heat dissipation channel 2054 is formed at the lower end of the front housing plate of the outer housing 2002.

Specifically, a cooling partition 2006 is arranged above the inner housing 2001, and the upper heat dissipation channel 2052 is formed between the cooling partition 2006 and the top housing plate of the outer housing 2002. A mounting partition 2007 is arranged at the back of the inner housing 2001, and the rear heat dissipation channel 2053 is formed between the mounting partition 2007 and the back housing plate of the outer housing 2002. A thermal insulation partition 2008 is arranged below the inner housing 2001, the thermal insulation partition 2008 is located below the heating element mounting plate to prevent heat from the lower heating device 2043 from dissipating downward, and the lower heat dissipation channel 2054 is formed between the thermal insulation partition 2008 and the bottom housing plate of the outer housing 2002. The air inlets 2055, the upper heat dissipation channel 2052, the rear heat dissipation channel 2053, the lower heat dissipation channel 2054, and the air outlets 2056 are in sequential communication. The oven cooling fan 2051 is located at the junction between the upper heat dissipation channel 2052 and the rear heat dissipation channel 2053.

The air inlets 2055 include first air inlets and second air inlets in communication with the outside, with the first air inlets distributed above the second air inlets. The drop-down door mechanism 2003 is internally provided with a door cooling air duct 2031, as well as a door air inlet 2032 and a door air outlet 2033 in communication with the door cooling air duct 2031. The door air inlet 2032 is located at the bottom or left/right side of the drop-down door mechanism 2003, and the door air outlet 2033 is located on the inner upper side of the drop-down door mechanism 2003. When the drop-down door mechanism 2003 is closed, the door air outlet 2033 faces the second air inlets, allowing the door cooling air duct 2031 to be in communication with the oven heat dissipation channel.

When the oven cooling fan 2051 is operating, external air enters the oven heat dissipation channel on the one hand directly through the first air inlets, and on the other hand, it enters the oven heat dissipation channel through the door air inlet 2032 and the door cooling air duct 2031, and is then discharged to the outside through the air outlets 2056, thereby enabling simultaneous cooling and heat dissipation for the drop-down door mechanism 2003 and the inner housing 2001.

A main control panel 400 is further arranged above the front housing plate, the main control panel 400 is provided with a display screen and corresponding keys, the main control panel 400 is separately connected to main control boards of the first apparatus 200 and the second apparatus 300, and the main control board of the first apparatus 200 is located within the oven heat dissipation channel and is configured to control operation of the baking device 2004 and the oven heat dissipation unit 2005. The first air inlets are located in a gap between the main control panel 400 and the drop-down door mechanism 2003.

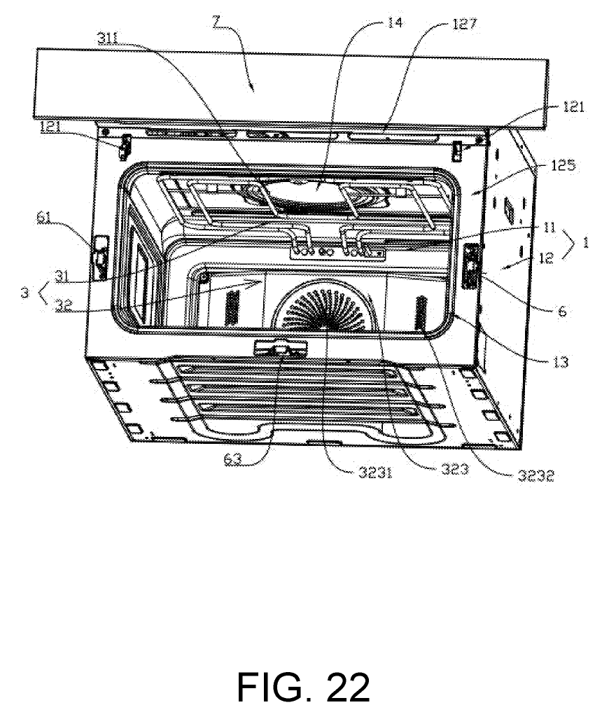

As shown in FIG. 22, the second apparatus 300 in this embodiment is a drawer-type microwave-oven combination appliance, and its structure is substantially the same as that of Embodiment 2, and will not be repeated herein.

In addition, the structure of the rear air frying device 2041 of the first apparatus 200 in this embodiment is substantially the same as that of the back heating mechanism 32 of the second apparatus 300. The above-mentioned air outlets 2056 are located in the gap between a control panel 7 and the drop-down door mechanism 2003.

In another variation of this embodiment, the second apparatus 300 may further be provided with a separate main control board or control panel 7 for controlling its own electrical components such as the microwave generating device 2, the electric heating device 3, and the drawer opening/closing device 5.

The above embodiments are only the preferred embodiments of the present disclosure, and are not intended to limit the scope of protection of the present disclosure accordingly. Therefore, any equivalent changes made based on the structure, shape, and principles of the present disclosure shall be covered by the scope of protection of the present disclosure.

What is claimed is:

1. A drawer-type kitchen appliance, comprising:
a chassis (1), having an inner liner (11) and an outer shell (12);
a left slide rail assembly (61), arranged between left side walls of the inner liner (11) and the outer shell (12);
a right slide rail assembly (62), arranged between right side walls of the inner liner (11) and the outer shell (12);
a door device (4), having a drawer storage frame (41) located within the inner liner (11), a door body (42) for sealing the inner liner (11), and side connectors (43) respectively installed on left and right sides of the door body (42), the side connectors (43) being mounted on the corresponding left slide rail assembly (61) and the right slide rail assembly (62), respectively; and
a drawer opening/closing device (5), arranged on one side of the chassis (1), and configured to drive the door device (4) to open and close, wherein
the drawer opening/closing device (5) comprises:
a synchronous belt assembly (51), having a driving pulley (511), a driven pulley (512), and a synchronous belt (513) arranged therebetween;
a motor (52), configured to drive the driving pulley (511) to rotate; and
a linkage part (53), having one end fixed to the synchronous belt (513) and the other end fixed to the side connector (43), wherein
the synchronous belt (513) drives the side connector (43) to perform linear reciprocating motion via the linkage part (53).

2. The drawer-type kitchen appliance according to claim 1, wherein the linkage part (53) comprises a linkage plate (531) and a fixing clamp block (532), the linkage plate (531) has a first fixing portion (5311) connected to the synchronous belt (513) and a second fixing portion (5312) connected to the side connector (43), and the first fixing portion (5311) is fixed to the synchronous belt (513) via the fixing clamp block (532).

3. The drawer-type kitchen appliance according to claim 2, wherein the first fixing portion (5311) is provided with a tooth slot (5313) adapted to a toothed surface of the synchronous belt (513) and at least one first connecting hole (5314) for connecting to the fixing clamp block (532),
the fixing clamp block (532) is L-shaped and is provided with a second connecting hole (5321) corresponding to the first connecting hole (5314) and an insertion slot (5322) for inserting the first fixing portion (5311), and a fastener is arranged between the first connecting hole (5314) and the second connecting hole (5321); and
the first fixing portion (5311) is installed on a toothed surface side of the synchronous belt (513), the fixing clamp block (532) is installed on a non-toothed surface side of the synchronous belt (513), an end portion of the first fixing portion (5311) is inserted into the insertion slot (5322) of the fixing clamp block (532), and an inner end of the first fixing portion (5311) is fixed to the fixing clamp block (532) via the fastener.

4. The drawer-type kitchen appliance according to claim 2, wherein the second fixing portion (5312) is bent to form a positioning protrusion (5316) and at least one first mounting hole (5315);
a tail portion of the side connector (43) is provided with a positioning slot (431) matching the positioning protrusion (5316) and a second mounting hole (432) corresponding to the first mounting hole (5315); and
the first mounting hole (5315) and the second mounting hole (432) are fixedly connected via screws.

5. The drawer-type kitchen appliance according to claim 1, wherein the synchronous belt assembly (51) further has a pulley mounting seat (514), and front and rear ends of the pulley mounting seat (514) are respectively provided with driving pulley mounting notches (5141) and driven pulley mounting notches (5142);
the driving pulley (511) is detachably arranged on the driving pulley mounting notches (5141) via a driving pulley auxiliary mounting bracket (515); and the driven pulley (512) has a driven pulley body and a driven shaft, and end portions of the driven shaft are detachably arranged within the driven pulley mounting notches (5142) via fixing nuts.

6. The drawer-type kitchen appliance according to claim 1, wherein the motor (52) is located above or below the synchronous belt assembly (51), an output wheel (521) is installed on a main shaft of the motor (52), an input wheel (522) rotating synchronously is arranged on one side of the driving pulley (511), and the output wheel (521) and the input wheel (522) are connected via an output belt (523).

7. The drawer-type kitchen appliance according to claim 1, wherein a limiting member (44) is arranged at a tail portion of the side connector (43), and a first micro switch (54) is arranged at a front end of the chassis (1);
when the door device (4) reaches an open position, the limiting member (44) triggers the first micro switch (54) and controls the motor (52) to stop; and/or, the door body (42) is provided with at least one pair of door lock assemblies (45), corresponding lock holes (121) are formed in the chassis (1), and a second micro switch is arranged inside each of the lock holes (121); and
when the door device (4) reaches a closed position, the door lock assemblies (45) contact the second micro switches and control the motor (52) to stop.

8. The drawer-type kitchen appliance according to claim 1, wherein a front vertical beam (122) and a rear vertical beam (123) are separately arranged on one side of the outer shell (12), and a slide rail fixing crossbeam (124) for installing the left slide rail assembly (61) or the right slide rail assembly (62) is arranged between the front vertical beam (122) and the rear vertical beam (123); and
the left slide rail assembly (61) or the right slide rail assembly (62) comprises a slide rail (611) fixed to the slide rail fixing crossbeam (124) and a slider (612) movably arranged on the slide rail, and the slide rail (611) is fixedly connected to the side connector (43).

9. The drawer-type kitchen appliance according to claim 1, wherein the drawer-type kitchen appliance further comprising at least one bottom slide rail assembly (63) arranged between bottom plates of the inner liner (11) and the outer shell (12); and
the door device (4) further has a bottom connector (46) connected to the bottom slide rail assembly (63).

10. The drawer-type kitchen appliance according to claim 9, wherein bottom rollers (47) for rolling on a bottom plate of the inner liner (11) and/or side wall rollers (48) for rolling on side plates of the inner liner (11) are respectively arranged on left and right sides of an inner side of the drawer storage frame (41) away from the door body (42).

11. The drawer-type kitchen appliance according to claim 1, wherein
a top of the inner liner (11) is provided with an inner liner microwave inlet (111) and a stirring cavity (112) in communication with the inner liner microwave inlet (111);
a microwave generating device (2) is installed on a top of the chassis (1), comprising:
a microwave generating mechanism (21), configured to generate microwaves;
a waveguide box (22), having a waveguide inlet portion (221) connected to the microwave generating mechanism (21) and a waveguide outlet portion (222) connected to the inner liner microwave inlet (111), and configured to guide the microwaves into the stirring cavity (112); and
a stirring mechanism (23), installed on the waveguide box (22), and provided with a stirring motor (231), a stirring shaft (232), and a stirring blade (233) located inside the stirring cavity (112), the stirring motor (231) driving the stirring blade (233) to rotate via the stirring shaft (232).

12. The drawer-type kitchen appliance according to claim 11, wherein the waveguide box (22) is provided with a shaft mounting hole portion (223), and the stirring shaft (232) is movably arranged inside the shaft mounting hole portion (223);
the stirring mechanism (23) further comprises:
a first driving member (234), shaped like an L, with one end clamped onto an output shaft of the stirring motor (231); and
a second driving member (235), having one end sleeved onto the stirring shaft (232), and the other end passing through the stirring shaft (232) to connect to the other end of the first driving member (234).

13. The drawer-type kitchen appliance according to claim 12, wherein the stirring shaft (232) is movably connected to the shaft mounting hole portion (223) via a shaft sleeve (236), an outer end of the shaft sleeve (236) is provided with a limiting flange, and a middle side wall thereof is provided with a limiting groove (2361); a limiting bump (2231) adapted to the limiting groove (2361) is provided inside the shaft mounting hole portion (223) for limiting an axial position of the shaft sleeve (236); and
the second driving member (235) abuts against the shaft sleeve (236) and limits an axial position of the stirring shaft (232).

14. The drawer-type kitchen appliance according to claim 11, wherein the waveguide box (22) comprises an upper waveguide box body (224) and a lower waveguide box body (225), edges of the upper waveguide box body (224) and the lower waveguide box body (225) being welded and fixed; and the upper waveguide box body (224) is provided with a tuning rod (226).

15. The drawer-type kitchen appliance according to claim 11, wherein the microwave generating device (2) further comprises a microwave cooling mechanism (24), the microwave cooling mechanism has a microwave cooling casing (241) and a microwave cooling fan (242), the microwave cooling casing (241) is internally provided with a microwave air inlet (243), a microwave cooling channel and a microwave air outlet (244) that are communicated in sequence, the microwave air outlet (244) is in communication with an outer shell exhaust hole (127) of the outer shell (12), and the microwave cooling fan (242) is located inside the microwave cooling channel; and
the microwave generating mechanism (21) comprises a frequency converter (211) and a magnetron (212) arranged within the microwave cooling channel.

16. The drawer-type kitchen appliance according to claim 11, further comprising a top heating mechanism (31) arranged on the top of the inner liner (11), wherein the top heating mechanism (31) is a top heating element, and a middle part of the top heating element is provided with a clearance portion (311) for avoiding microwaves; and
the microwave generating device (2) and the stirring cavity (112) are both located on the top of the inner liner (11), and the clearance portion (311) is located directly below the stirring cavity (112).

17. The drawer-type kitchen appliance according to claim 11, further comprising a back heating mechanism (32) arranged on a back of the inner liner (11), wherein the back heating mechanism (32) comprises a back heating element (321), a circulating fan (322), and a heating element shield (323), a back heating chamber is formed between the heating element shield (323) and a back plate of the inner liner (11), the back heating element (321) and the circulating fan (322) are installed inside the back heating chamber, a plurality of first vent holes (3231) are formed at positions of the heating element shield (323) corresponding to the circulating fan (322), and a plurality of second vent holes (3232) are formed at positions of the heating element shield (323) corresponding to the back heating element (321).

18. A double-layer combined drawer-type kitchen appliance, comprising:
a rack (100);
a first apparatus (200), installed in an upper portion of the rack (100); and
a second apparatus (300), installed in a lower portion of the rack (100), wherein
the second apparatus (300) comprises:
a chassis (1), having an inner liner (11) and an outer shell (12) arranged around a periphery of the inner liner (11);
a door device (4), having a drawer storage frame (41) located within the inner liner (11), a door body (42) for sealing the inner liner (11), and side connectors (43) respectively installed on left and right sides of the door body (42), the side connectors (43) being respectively installed inside the chassis (1) via slide rail assemblies (6); and
a drawer opening/closing device (5), arranged on one side of the chassis (1), and configured to drive the door device (4) to open and close, wherein
the drawer opening/closing device (5) comprises:
a synchronous belt assembly (51), having a driving pulley (511), a driven pulley (512), and a synchronous belt (513) arranged therebetween;
a motor (52), configured to drive the driving pulley (511) to rotate; and
a linkage part (53), having one end fixed to the synchronous belt (513) and the other end fixed to the side connector (43), wherein
the synchronous belt (513) drives the side connector (43) to perform linear reciprocating motion via the linkage part (53).

19. The double-layer combined drawer-type kitchen appliance according to claim 18, wherein a top of the inner liner (11) is provided with an inner liner microwave inlet (111) and a stirring cavity (112) in communication with the inner liner microwave inlet (111);
the second apparatus (300) further comprises a microwave generating device (2) installed on a top of the chassis (1), comprising:
a microwave generating mechanism (21), configured to generate microwaves;
a waveguide box (22), having a waveguide inlet portion (221) connected to the microwave generating mechanism (21) and a waveguide outlet portion (222) connected to the inner liner microwave inlet (111), and configured to guide the microwaves into the stirring cavity (112); and
a stirring mechanism (23), installed on the waveguide box (22), and provided with a stirring motor (231), a stirring shaft (232), and a stirring blade (233) located inside the stirring cavity (112), the stirring motor (231) driving the stirring blade (233) to rotate via the stirring shaft (232).

20. The double-layer combined drawer-type kitchen appliance according to claim 18, wherein:
the first apparatus (200) comprises:
an inner housing (2001), having a baking cavity;
an outer housing (2002), arranged around a periphery of the inner housing (2001);
a drop-down door mechanism (2003), arranged on a front side of the outer housing (2002), and configured to seal the baking cavity;
a baking device (2004), arranged on the inner housing (2001), and configured to heat food in the baking cavity; and
an oven heat dissipation unit (2005), comprising an oven heat dissipation channel and an oven cooling fan (2051) arranged inside the oven heat dissipation channel, wherein
the oven heat dissipation channel comprises an upper heat dissipation channel (2052) arranged above the inner housing (2001), a rear heat dissipation channel (2053) arranged at a back of the inner housing (2001), and a lower heat dissipation channel (2054) arranged below the inner housing (2001),
at least one air inlet (2055) in communication with the upper heat dissipation channel (2052) is formed at an upper end of a front housing plate of the outer housing (2002), and at least one air outlet (2056) in communication with the lower heat dissipation channel (2054) is formed at a lower end of the front housing plate of the outer housing (2002).
